(19) United States
(12) Patent Application Publication
(10) Pub. No.: US 2013/0333515 A1
(43) Pub. Date: Dec. 19, 2013

(54) FLEXSPLINE MOUNTING STRUCTURE OF HARMONIC REDUCER

(71) Applicant: Chun-Shen YEH, Taipei City (TW)

(72) Inventor: Chun-Shen YEH, Taipei City (TW)

(21) Appl. No.: 13/607,340

(22) Filed: Sep. 7, 2012

(30) Foreign Application Priority Data
Jun. 13, 2012 (TW) 101211401

(51) Int. Cl. F16H 35/00

(52) U.S. Cl. 74/640

(57) ABSTRACT

A flexspline mounting structure of a harmonic reducer includes a circular spline, a flexspline and a wave generator. The flexspline is fixed and mounted to a mounting base with a plurality of elastic walls, and then the mounting base is mounted to the casing of the reducer. The circular spline is connected to an output shaft, so when the power source drives the wave generator to rotate, the flexspline also drives the circular spline and the output shaft to rotate simultaneously. By mounting the flexspline on the flexible elastic walls of the mounting base, the present invention can overcome the drawback of the uneven internal stress of the flesxspline during deformation, so the rupture of the flexspline can be reduced and the life thereof can be prolonged.

### BACKGROUND OF THE INVENTION

1. Field of the Invention

The present invention relates to a harmonic reducer, more particularly, relates to a flexspline mounting structure included in the harmonic reducer.

2. The Prior Arts

The harmonic reducer is a gear drive which uses flexible components to generate flexible mechanical wave to transmit power and motion. It is also called a “harmonic gear drive” (also known as the harmonic drive).

FIG. 1 shows the structure of a conventional harmonic reducer which comprises three components: a circular spline A which disposes an internal gear, a flexspline B which disposes an external gear and a wave generator C. When the harmonic drive functions as a reducer, the conventional type of operation is to set the circular spline A as stationary, the wave generator C as active operating and the flexspline B as the power output.

Flexspline B is a thin-walled gear which has a greater range of elastic deformation, where the inner diameter is equal or slightly larger than the total outer diameter of the wave generator. The wave generator C is a component which can elastically deform the flexspline B within a controllable range. The wave generator C disposes a central axis, wherein the central axis is installed with a deformable rolling bearing to form a roller. The wave generator C is then assembled inside the flexspline B so the outer wall of the wave generator C and the inner wall of the flexspline B are compressed against each other tightly. The wave generator C is connected to a power source which is typically a motor. When the wave generator C is installed into the flexspline B, the flexspline is forced from the round shape into an oval shape. The external gear on the two ends of the long axis of the oval are further pushed to be completely engaged with the internal gear of the circular spline A, whereas the external gear near the two ends of the short axis are completely disengaged with the internal gear of the circular spline. The rest of the external gear on other parts of the perimeter is in a transition state between engaged and disengaged. When the wave generator rotates continuously, the deformation of the flexspline also changes continuously, whereas the engaging state between the flexspline B and circular spline A also changes simultaneously. The cycle of the engagement starts from engaging in, engaged, engaging out, disengaged and then repeats onwards so the flexspline slowly rotates in the opposite direction of the wave generator C in relative to the circular spline.

During the driving process, the number of times a point on flexspline B deforms during one revolution of the wave generator is defined as the wave number n. The most widely used drive type is the double wave drive due to its smaller flexspline stress, simpler structure and a greater drive ratio. The pitches of the gears in the flexspline and circular spline of the harmonic gear drive are the same, but the numbers of the gear teeth are not.

When the circular spline is fixed, the wave generator is rotated and the flexspline is driven to rotate. The drive ratio of the harmonic gear drive is equal to: i=−B1/(A1−B1), where A1 and B1 are the number of gear teeth of the circular spline A and the flexspline B, respectively.

Because of the large number of the flexspline gear tooth, the harmonic gear drive can acquire a large drive ratio.

Because of the surface contact between the gear tooth and the high number of simultaneously engaged gear teeth, the harmonic reducer has the advantages of a smaller load per unit area and a higher bearing capacity compared to other drive types during the harmonic drive process. The harmonic reducer also has the benefit of a large drive ratio, where the drive ratio of a single stage harmonic gear drive can be i=70˜500. Furthermore, The harmonic reducer has the advantages of a small size, light weight, high drive efficiency, long life, high stability, impact free, low noise and high motion accuracy; therefore, the harmonic reducer has a wide range of applications.

However, during the drive process of the reducer, the flexspline needs to endure a larger alternating load which causes the flexspline to be damaged easily. In this case, the required fatigue strength, and the required technique level of process and heat treatment of the flexspline material are higher. The processing technique is also more complex.

In addition, in the conventional harmonic reducer, the distance D between the output shaft and the engaging location of circular spline and flexspline is greater, which can cause the sway due to different axis and the increase of heat and noise due to friction.

In order to solve the previous mentioned problems, Taiwan Patent Registration No. 101210934 filed by the present applicant disclosed a harmonic reducer, which has the wave generator thereof assembled with the flexspline and a power source, so the flexspline deforms and engages with the circular spline partially. The flexspline is fixed while the circular spline is connected to an output shaft. When the power source drives the wave generator to rotate, the flexspline also drives the circular spline and the output shaft to rotate simultaneously.

However, the flexspline of the harmonic reducer described above is mounted directly to the casing of the reducer or other components, so uneven internal stress easily occurs when flexspline deforms during the driving process. In addition, the amount of deformation in the flexspline is also limited so the adjustment of the tooth difference between the circular spline and the flexspline is not allowed; therefore the need of a greater output range cannot be satisfied through various reduction ratios.

### SUMMARY OF THE INVENTION

A primary object of the present invention is to overcome the drawbacks of a general reducer with a flexspline mounted to the casing of the reducer of other components directly. In such reducer, the flexspline ruptures easily due to the uneven internal stress occurs during the deformation in the drive process. In addition, the amount of deformation in the flexspline is also limited so the adjustment of the tooth difference between the circular spline and the flexspline is not allowed; therefore the need of a greater output range cannot be satisfied through various reduction ratios.

The flexspline mounting structure of a harmonic reducer provided in the disclosure is characterized in that the flexspline is mounted to the flexible mounting base, and then the mounting base is mounted to the casing of the reducer. Through the flexibility provided by the mounting base, the stress received by the flexspline can be more even during the deformation in the drive process. Furthermore, the amount of deformation can be increased which allows the adjustment of the tooth difference between the circular spline and the flexspline, thus acquiring various reduction ratios to satisfy the need of a greater output range.

The present invention comprises a mounting base and a flexspline. The mounting base has an annular body, where a plurality of elastic walls is disposed circumferentially in the inner perimeter of the mounting base. The outer perimeter of the flexspline is mounted to the inner perimeter of the mounting base, which is surrounded by the elastic walls.

In the present invention, a plurality of holes are disposed on the outer perimeter of the flexspline, and each elastic wall has perforations corresponding to the holes, so the flexspline can be mounted to the elastic walls by using mounting members to pass through both the holes and the perforations.

By mounting the flexspline on the flexible elastic walls of the mounting base, the present invention can overcome the drawback of the uneven internal stress of the flesxspline during deformation, so the rupture of the flexspline can be reduced and the life thereof can be prolonged. Furthermore, the flexible elastic walls not only allow the flexspline to greater deform, also allow the adjustment of the elliptical curvature of the wave generator, so the difference between the gear tooth can be adjusted to achieve various reduction ratio, and also to satisfy a greater range of output needs.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a plane section view showing the structure of a conventional harmonic reducer.

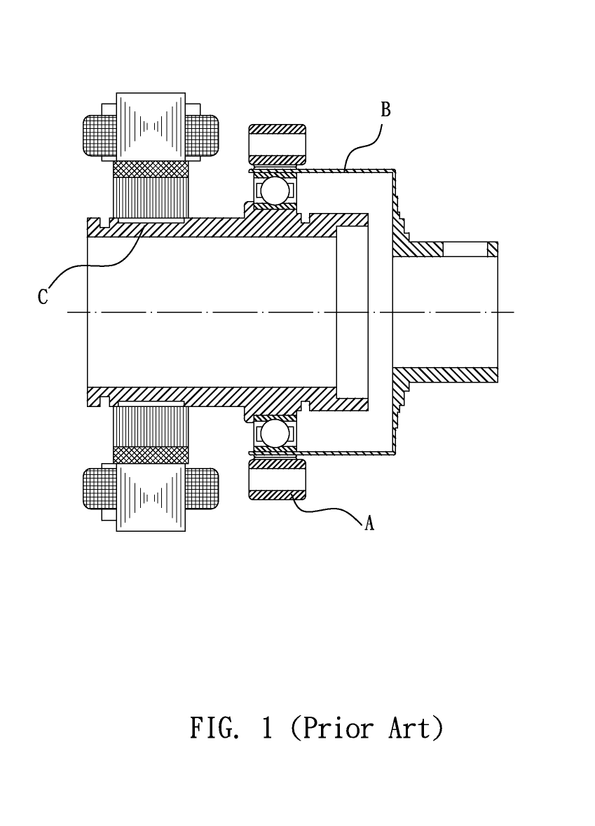

FIG. 2 is an exploded perspective view showing the assembling relations between each components of the harmonic reducer of the present invention.

FIG. 3 is a plane section view showing the structure of the harmonic reducer of the present invention.

FIG. 4 is a plane schematic view showing one end of the harmonic reducer of the present invention.

### DETAILED DESCRIPTION OF THE PREFERRED EMBODIMENT

An embodiment of the present invention will be described in details with reference to the drawings so that this disclosure is thorough and fully conveys the concept of the invention to those who skilled in the art.

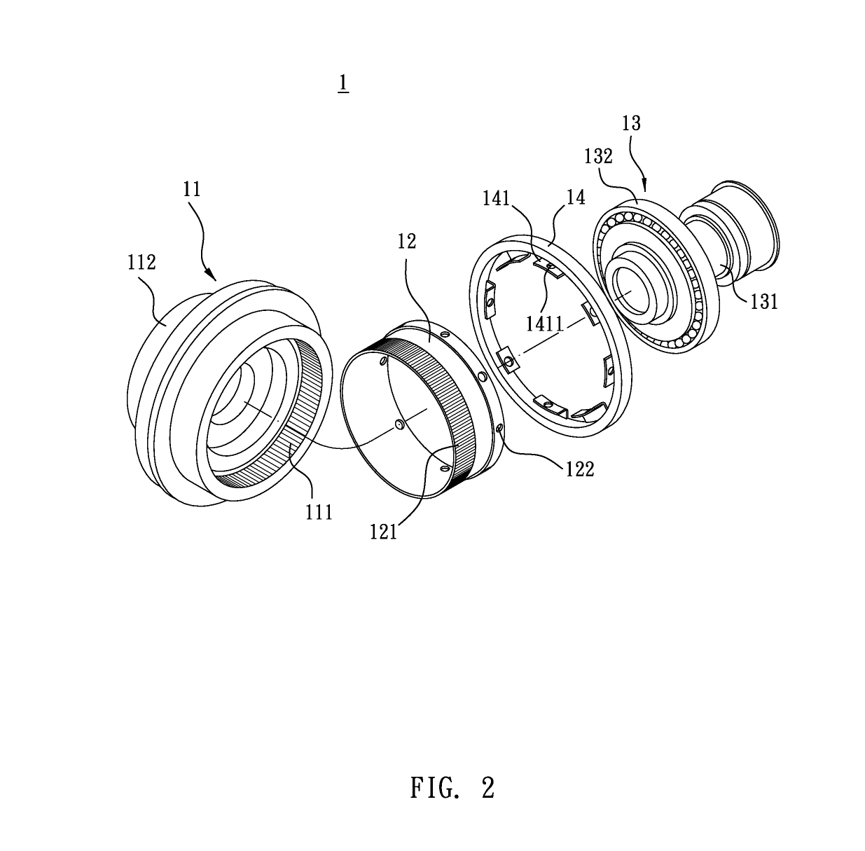

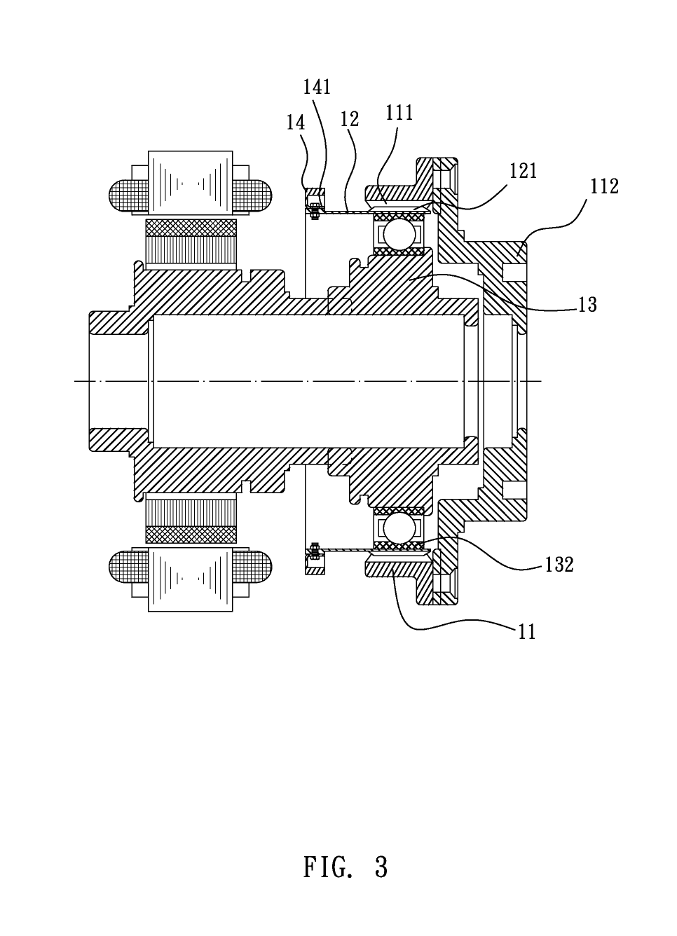

As shown in FIG. 2 and FIG. 3, the harmonic reducer with stationary flexspline 1 provided in the present invention comprises a circular spline 11, a flexspline 12, a wave generator 13 and a mounting base 14. The circular spline 11 disposes an internal space within and an inner circumferential wall of the internal space forms an internal gear 111 which is composed of a plurality of internal gear tooth. The circular spline 11 is connected to an output shaft 112. In the preferred embodiment of the present invention, the output shaft 112 is integrated at an end of the circular spline 11 as one piece, wherein the output shaft 112 can dispose a plurality of holes or screw holes for assembling additional output device for power output.

The flexspline 12 can be manufactured into the precise shape and size with a tube material with suitable thickness. A gear hobbing machine is then used to form the external gear 121 composed of a plurality of external gear tooth on its outer perimeter, and an end of the flexspline further disposes a plurality of holes 122.

The mounting base 14 has an annular body, where a plurality of elastic walls 141 is disposed circumferentially in the inner perimeter of the mounting base. Preferably, the elastic wall 141 is an elastic strip processed by impact molding and placed in the inner perimeter of the mounting base 141. At least one perforation 1411 is reserved on the elastic strip, and then the elastic strip is bended until it is close to 90 degrees to form the elastic wall 141.

The wave generator 13 of the present invention is a deformable bearing which disposes a central axis 131 and an outer ring 132, wherein the central axis 131 is an oval which is close to a circle in shape so the mutual rotation is allowed between the outer ring 132 and the central axis 131. The central axis is connected to a power source (not shown in graph) which is normally a motor.

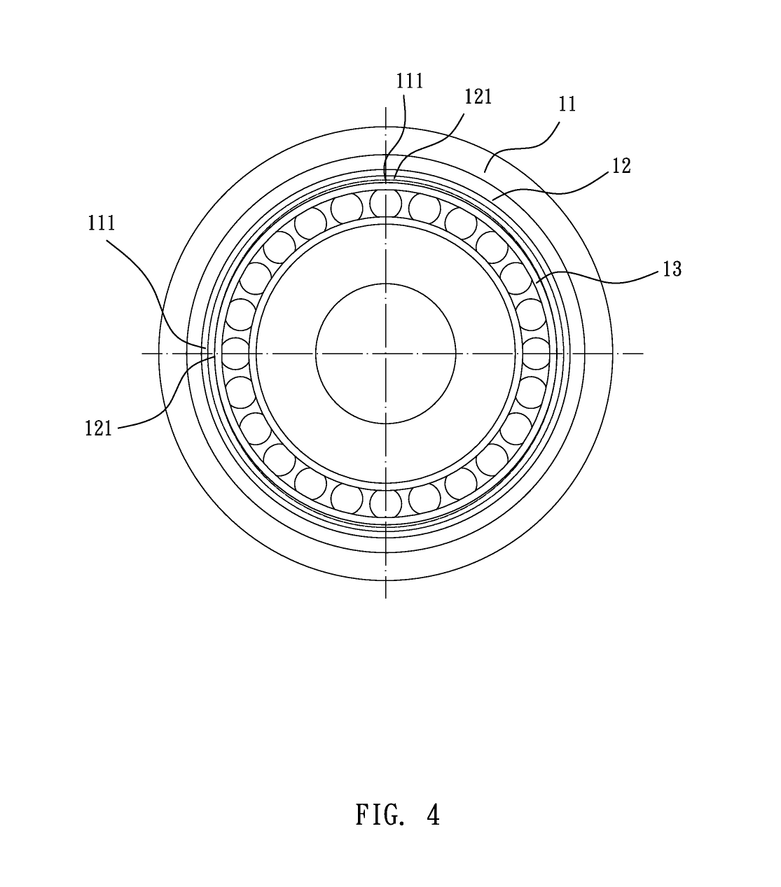

The assembling method of each components of the harmonic reducer 1 in the present invention will be described next. First, the outer perimeter of the flexspline 12 is assembled in the inner perimeter of the mounting base 14 which is surrounded by the elastic walls 141. Screws or other mounting members are next passed through the perforations 1411 of the elastic walls 141 and the holes 122 of the flexspline 12, so the flexspline 12 is mounted on the elastic walls 141 of the mounting base 14. The mounting base 14 is then mounted to the casing of the reducer (not shown in graph) while the elastic walls 141 connect directly to the flexspline 12. Next, flexspline is assembled in the internal space of the circular spline 11, and the wave generator 13 is installed onto the inner perimeter of the flexspline 12. The flexspline 12 is a thin-walled gear which can be greater elastically deformed, and the inner diameter of the flexspline 12 is equal or slightly greater than the total outer diameter of the wave generator 13, while the wave generator 13 is a component which can deforms the flexspline elastically in a controllable range. When the wave generator 13 is installed into the flexspline 12, the ends of the flexspline 12 is forced from the circular shape into an oval shape (as shown in FIG. 4). The external gear 121 near the two ends of the long axis of the oval is further pushed and engages with the internal gear 111 of the circular spline 11 completely, whereas the external gear near the two ends of the short axis of the oval is completely disengaged with the internal gear of the circular spline. The rest of the external gear on the other parts of the perimeter is in a transition state between engaged and disengaged. When the wave generator 13 rotates continuously, the deformation of the flexspline 12 changes continuously, so the engaging status of flexspline 12 and circular spline 11 also changes constantly. The cycle of the engagement starts from engaging in, engaged, engaging out, disengaged and then repeats onwards so the circular spline 11 slowly rotates in the same direction of the wave generator 13 in relative to the flexspline 12.

By mounting the flexspline 12 on the flexible elastic walls 141 of the mounting base 14, the present invention can overcome the drawback of the uneven internal stress of the flesxspline during deformation, so the rupture of the flexspline can be reduced and the life thereof can be prolonged. Furthermore, the flexible elastic walls 141 not only allow the flexspline 12 to greater deform, also allow the adjustment of the elliptical curvature of the wave generator 13, so the difference between the gear tooth can be adjusted to achieve various reduction ratio, and also to satisfy a greater range of output needs.

The preferred embodiment described above is disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A flexspline mounting structure of a harmonic reducer, comprising:
a mounting base, which has an annular body, and a plurality of elastic walls are disposed circumferentially in the inner perimeter of the mounting base; and
a flexspline, the outer perimeter thereof is mounted to the inner perimeter of the mounting base which is surrounded by the elastic walls.

2. The flexspline mounting structure of a harmonic reducer as claimed in claim 1, wherein a plurality of holes are disposed on the outer perimeter of the flexspline, and each elastic wall has at least one perforation corresponding to the hole thereof, so the flexspline can be mounted to the elastic wall by using mounting members to pass through both the holes and the perforations.
